(19) United States
(12) Patent Application Publication
(10) Pub. No.: US 2014/0027689 A1
(43) Pub. Date: Jan. 30, 2014

(54) Guide Member and a Method for Positioning a Cable into a Sewerage System

(71) Applicants: Johannes Gerhardus Spijker, Dedemsvaart (NL); Klaas Alexander Nicolai, Dedemsvaart (NL)

(72) Inventors: Johannes Gerhardus Spijker, Dedemsvaart (NL); Klaas Alexander Nicolai, Dedemsvaart (NL)

(73) Assignee: JELCER-IP B.V., Dedemsvaart (NL)

(21) Appl. No.: 13/981,866

(22) PCT Filed: Jan. 25, 2012
(86) PCT No.: PCT/NL2012/050040

§ 371 Date: Oct. 14, 2013

(30) Foreign Application Priority Data
Jan. 25, 2011 (NL) 2006064

(51) Int. Cl. H02G 1/00

(52) U.S. Cl. CPC H02G 1/00
USPC 254/134.3 FT

(57) ABSTRACT

A guide member (40) comprises a sleeve (41) for positioning into an entrance (15A) of a first branch pipe (20A) in a sewerage system, which entrance (15a) provides access to a main pipe (10), wherein a telecommunication cable system is inserted into said sewerage system, which telecommunication cable system comprising a cable trunk (2) present in the main pipe (10) and housing a plurality of cables (1A, 1B), of which plurality of cables a first cable (1A) extending into the first branch pipe (20A), wherein a first aperture (3) is present in said cable trunk (2) at or near the entrance (15A) of the first branch pipe (20A) through which the first cable (1A) leaves the cable trunk (2), which said guide member (40) comprises a trunk support part (42) projecting into the main pipe (10) and positioning the cable trunk (2) in a desired angular position near the entrance (15A) of the first branch pipe (20A), which guide member (40) further comprises a cable guide (45) for supporting the first cable (1A) at an outside of the sleeve (41), characterized in that the trunk support part (42) comprises a window in a protective member such that the aperture (3) is substantially aligned to said cable guide (45).

### FIELD OF THE INVENTION

The invention relates to a guide member comprising a sleeve for positioning into an entrance of a first branch pipe in a sewerage system, which entrance provides access to a main pipe, wherein a telecommunication cable system is inserted into said sewerage system.

The invention also relates to a method of positioning a first cable into a sewerage system comprising a main pipe and a first branch pipe with an entrance in the main pipe, comprising the steps of providing the first cable into the first branch pipe and extending to the main pipe, and introducing a sleeve of a guide member into the entrance of the first branch pipe, wherein the first cable is arranged between a surface of the first branch pipe and the sleeve, the guide member being provided with a cable guide thereto.

### BACKGROUND OF THE INVENTION

Such a guide member and such a positioning method are known from EP1309054. The telecommunication cable system herein comprises optical cables, such as optical fibre cables, including a first cable extending into the first branch pipe to be connected to a corresponding house or building. The first cable further extends through the main pipe, typically to a central access point. In order to prevent that the plurality of cables are distributed throughout the main pipe, the cables are suitably inserted into a cable trunk. A first aperture in the cable trunk enables the first cable to leave the cable trunk and access the first branch pipe.

Typically, the entrance of the first branch pipe into the main pipe are formed in an upper part of the main pipe. The first branch pipe extends thereto substantially vertically or with an oblique angle. Therefore, when the cable trunk is laid along an upper middle part within the main pipe, it will not hinder the sewerage flow from any branch pipe. However, this is not always the case. Thereto, EP1309054 specifies the provision of a guide member which is formed of a tubular part or sleeve and which is inserted into the first branch pipe. The guide member may further comprises a collar part which abuts with the inner surface of the main pipe at the fringe of the entrance of the first branch pipe. The tubular (i.e. cylindrical) part is formed with a diameter expansion means in the portion which is inserted into the branch pipe. Examples of such diameter expansion means are a spring ring of stainless steel, a metal ring which can be expanded by plastic deformation, and so forth, each one of which can expand the cylindrical part from inside pressing it against the inner surface of the branch pipe.

The first cable extends from the cable trunk in the main pipe to the first branch pipe, wherein it is guided to the outer periphery of the sleeve and passes through the gap between the sleeve and the first branch pipe. The cable trunk skirts around the outer periphery of a lip part of the sleeve and thus extends along the upper middle part of the main pipe without traversing the entrance of the first branch pipe. This lip part of the sleeve is thus effectively a trunk support part of the guide member. EP1309054 thereafter specifically solves a problem of how to prevent that the first cable and/or an accompanying tension member diagonally traverse the first branch pipe and thus possibly hindering the sewerage flow. EP1309054 thereto provides the guide member with a rotary part such that the first cable may be brought from one side of the branch pipe to an opposite side. Thereafter a resin coating is applied to the sleeve and the inner surface of the first branch pipes, or at least portions thereof, to cover the gap between sleeve and inner surface and fix the position of the first cable It is however a disadvantage of the construction applied in EP1309054 that the connection of the first cable between the cable trunk and the sleeve of the guide member remains a sensitive and vulnerable element in the system. Here the first cable could break due to unexpected twisting or turning of the cable trunk. And when the first cable would break there, after the assembly process, the first cable needs to be replaced. This is however difficult due to the presence of the cable trunk and the location between sleeve and first branch pipe that has been fixed. It could be that the tension members of EP1309054 provide some stability and robustness against fracture of the first cable. However the tension member itself constitutes an additional element to be assembled throughout the main pipe and the first branch pipe, which adds cost and complexity.

It is therefore an object of the present invention to reduce the vulnerability of the cable system as inserted in the sewerage system without giving rise to higher levels of complexity during the assembly of the cables, that extend through the main pipe and branch pipe.

### SUMMARY OF THE INVENTION

According to a first aspect, the invention provides a guide member comprising a sleeve for positioning into an entrance of a first branch pipe in a sewerage system, which entrance provides access to a main pipe, wherein a telecommunication cable system is inserted into said sewerage system, which telecommunication cable system comprising a cable trunk present in the main pipe and housing a plurality of cables, of which plurality of cables a first cable extending into the first branch pipe, wherein a first aperture is present in said cable trunk at or near the entrance of the branch pipe through which the first cable leaves the cable trunk, which said guide member comprises a trunk support part projecting into the main pipe and positioning the cable trunk in a desired angular position near the entrance of the branch pipe, which guide member further comprises a cable guide for supporting the cable at an outside of the sleeve, characterized in that the trunk support part comprises a protecting member covering the cable trunk over a predefined distance at least at a side facing away from an adjacent inner surface of the main pipe, which protecting member comprises a window, through which the first aperture of the cable trunk is to be exposed. Preferably a clamp is present for fixation of the cable trunk of the defined desired axial position and orientation relative to the first branch pipe, such that the first aperture is substantially aligned to said cable guide. According to a second aspect, the invention provides a method of positioning a first cable into a sewerage system comprising a main pipe and a first branch pipe with an entrance in the main pipe, comprising the steps of:
Providing the first cable into the first branch pipe and extending to the main pipe;
Inserting the first cable into a cable trunk through an aperture in the cable trunk, and moving the cable trunk thereafter to a location at or near the entrance of the first branch pipe;
Introducing a sleeve of a guide member into the entrance of the first branch pipe, wherein the first cable is arranged between a surface of the first branch pipe and the sleeve, the guide member being provided with a cable guide thereto;
Positioning the cable trunk to a desired angular position relative to the entrance of the first branch pipe by getting it supported through a trunk support part of the guide member, and
Defining a desired axial position and orientation of the cable trunk relative to the first branch pipe by means of a protective member with a window of the cable trunk part, said definition step of the desired axial position and orientation further comprising a step of aligning said window relative to the first aperture. Preferably, said position and orientation are fixation by clamping the cable trunk into a clamp that is part of the trunk support part, such that the first aperture is substantially aligned to said cable guide.

According to a third aspect, the guide member of the invention is used for insertion into an entrance of a first branch pipe in a sewerage system and for protection of a first cable extending from the first branch pipe into a main pipe of the sewerage system. This use more specifically relates to a use for guiding the first cable in the first branch pipe between an outside of a sleeve of said guide member and a wall of said first branch pipe and for positioning and supporting a cable trunk on a trunk support part of the guide member, therewith also guiding the first cable from said position between sleeve and wall to an aperture in said cable trunk positioned on the trunk support part.

The use of a window in a protective member has significant advantages in the positioning and during use. First of all, the positioning is much better, and can be fine-tuned due to overlap between the aperture and the window, secondly, the positioning is more robust; the risk of rotation or shifting of the trunk is reduced. It is to be observed that such rotation is particularly a risk upon cleaning, which occurs with aggressive chemical but also heavy mechanical means including chains and the like. However, the impact of animals and other uncontrollable influences during various weather conditions should not be forgotten.

The protective member, suitably made of a hard and suitably inert material herein specifically protects the first cable against shocks and attacks from chains and other harsh mechanical means using in sewerage cleaning. The protective member preferably comprises stainless steel, but alternatives are not excluded. Alternatively, the window may be closed, and the guide member is introduced into the entrance of the first branch pipe prior to the provision of the first cable. The first cable may then be guided through the window while being drawn through the sewerage system. In a further alternative, the window may be closed and the first cable is fit through the window before the cable is inserted into the cable trunk. As the latter insertion of the cable into the cable trunk typically occurs outside the sewerage system and/or in an access location thereof, the guide member would then also be inserted from such access location and be moved through the main pipe to the first branch pipe.

Particularly, the window has a smaller size than the first aperture, so that the fine-tuning easily occurs by overlapping said window and the first aperture. The larger extension of the first aperture therewith allows some flexibility to the axial position, which facilitates the assembly process. More suitably, the window has an oval shape.

The use of a clamp for fixation of the definition of both the axial position and the orientation of the cable trunk strongly reduces the vulnerability. The clamp may be present to a lateral side of the clamp, so as to enable assembly of the clamp around the trunk and particularly the aperture therein, just before, upon or after introduction of the guide member into the entrance of the first branch pipe.

While the clamp suitably extends around the cable trunk over an angle of at least 120 degrees, more preferably at least 180 degrees, for instance around 240 degrees and optionally more, such as around the cable trunk, it is not necessary that the clamp and the protective member have the same angular extension. This is essentially a design issue; a larger angular extension provides a better protection, but also adds mass to the guide member and may, particularly if the angular extension is too large, constitute an undesired burden for the assembly of the cable trunk into the clamp. In one suitable implementation, the protective member extends with an angular extension in the range of 60-210 degrees, particularly 90-180 degrees, between a first and a second clamping portion.

As an alternative to a clamp, use can be made of suitable other clamping or fixation solutions.

In one embodiment of the method, the first cable is first provided with a hose prior to the insertion into the cable trunk. This has the major benefit that the first cable may be removed actively (e.g. drawn away), even if the first cable has been attached to the guide member through the provision of a coating to cover a gap between the sleeve and the inner surface of the first branch pipe.

According to a further aspect of the invention, a sewerage pipe robot is provided, as well as its use for positioning a sleeve of a guide member into an entrance of a first branch pipe in a main pipe of a sewerage system and for positioning a cable trunk with an aperture on a trunk support part of the guide member in a desired axial position and orientation of the cable trunk relative to the first branch pipe, particularly in line with the above mentioned invention, said robot comprising a lift and a rotating member with which the guide member can be positioned and inserted.

More specifically, the lift is provided with a rotatable chassis, such that the rotating member may be positioned into the entrance of a first branch pipe that is located adjacent to the top of the main pipe. The rotating member may be provided with an upstanding wall corresponding with the shape of the sleeve of the guide member, and for circumference of said sleeve, said wall leaving a gap for the trunk support part of the guide member.

According to again a further aspect, a system of a sewerage pipe robot and a guide member in accordance with the invention, particularly for use in the method of the invention is provided. This system will in use by extending with the cable trunk with an aperture that is positioned and supported by the trunk support part of the guide member, and which is taken up with the guide member by the robot. The system additionally comprises a first cable extending from the first branch pipe between the sleeve of the guide member and an inner wall into the cable trunk via its aperture.

In a further aspect, the invention relates to a sewerage pipe robot with a lasso tool, which is able to catch a first cable when extending from a first branch pipe into a main pipe. The lasso tool is typically ring-shaped defining a inner space in which the first cable is to be caught. Suitably, clamping means are present so as to clamp the first cable after catching, and ensuring that it is held when the robot moves. The robot may further be provided with a lamp and a camera so as to improve its operation by visual inspection. Clearly, the visual inspection may be driven manually, through a remote connection, and/or on the basis of image recognition. The invention also relates to the use of said sewerage pipe robot for catching the first cable, and particularly a block attached to said first cable in a tip section thereof. More specifically, the invention relates to the use of said robot in the context of the above mentioned method for positioning a first cable into a sewerage system.

### BRIEF INTRODUCTION OF THE FIGURES

These and other aspects of the invention will be further elucidated with reference to the figures, in which:

FIG. 1a-1e shows in diagrammatical cross-sectional view a sequence of stages in one embodiment of the method in accordance with the invention;

FIG. 2 shows in diagrammatical, cross-sectional view the guide member in one embodiment of the invention;

FIG. 3 shows in diagrammatical, top view the guide member of FIG. 2 in a view indicated with the arrow A in FIG. 2, and

FIG. 4 shows in diagrammatical, side view the guide member of FIG. 2 in a view indicated with the arrow B in FIG. 2.

FIG. 5A shows in diagrammatical side view a robot with lasso tool in accordance with one embodiment of the invention;

FIG. 5B shows in diagrammatical top view the robot of FIG. 5A;

FIG. 6 shows in bird's eye perspective an embodiment of the sewerage pipe robot of the invention for inserting the guide member into the entrance of the first branch pipe; and

FIG. 7 shows the robot of FIG. 6 in a diagrammatical view inside the main pipe of the sewerage system.

### DETAILED DESCRIPTION OF ILLUSTRATED EMBODIMENTS

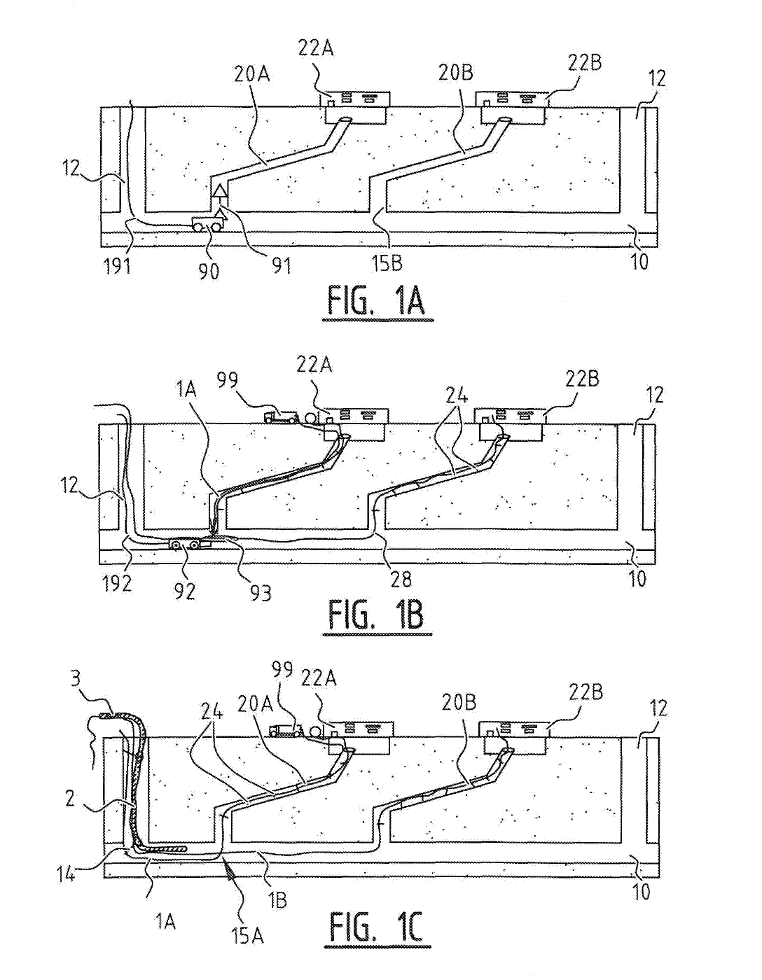

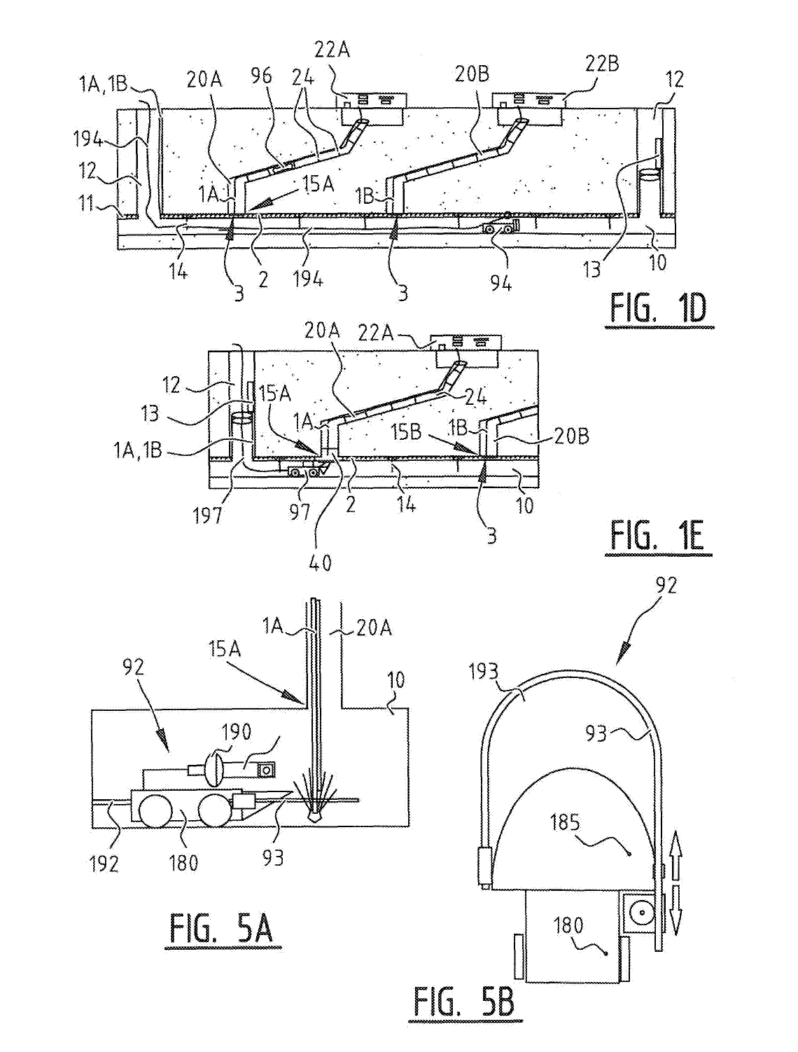

The figures are not drawn to scale and are intended for illustrative purposes. Equal reference numerals in different figures refer to same or similar features. It is observed with reference to FIG. 1a-1e that the first branch pipe 20A and the second branch pipe 20B are essentially corresponding in the shown embodiment. For any feature (for instance 1A) in relation to the first branch pipe 20A, a corresponding feature (i.e. 1B) will be present in the second branch pipe 20B, and vice versa, even if only one of both is indicated in the Figures.

FIG. 1a-e show in diagrammatical views five stages of the method of the invention. This method comprises the provision of a first cable 1A and second cable 1B from individual buildings 22A, 22B to a central access point 12. The central access 12 is typically a pipe that is accessible from a street. The path runs through a main pipe 10 and a first branch pipe 20A and a second branch pipe 20B. While the main pipe 10 is herein shown to be a single pipe, it is not excluded that the main pipe corresponds to a pipe system in one embodiment. Generally, the main pipe 10 and the first and second branch pipes 20A, 20B are part of a sewerage system. It will be seen that the shown method comprises the provision and the positioning of individual cables. In one embodiment, the signals from and to the first cable 1A and second cable 1B may be transported to a further transmission system from the access point 12. This further transmission system could be wireless or wired. If wired, it could again make use of the sewerage system or make use of a cable network provided separately. Any electronic conversion may occur at the access point 12, so as to improve signal integrity and reduce losses, as will be known to the skilled person in the relevant art. The optical cable is intended to be for use for the transmission of telecommunication signals, such as telephone and fax, internet connections, and broadcast signals. Use for the transmission of further signals is not excluded. While the specific embodiment of the method is preferred, it is to be understood that alternatives may be envisaged, and the focus of the present invention is particularly on the step shown in FIG. 1E.

FIG. 1A shows a first step of the method in which the main pipe 10 and the first and second branch pipe 20A, 20B are inspected. Use is made of an inspection robot. The robot 90 is provided with camera, positioning means and other electronic inspection equipment. The robot 90 is coupled over a cable 190 to a monitoring system, for instance a computer or even a telecommunication connection to a central database. It is understood that a cable connection 190 is preferred over a wireless connection in view of the underground location of the main pipe 10 and the branch pipes 20A, 20B. The cable connection 190 may further provide energy to the robot 90, but this is not necessary or preferred. Typically, the robot will be provided with a motor that is driven with a local battery or with a combustion engine as known to the skilled person. Inspection robots 90 for use in underground locations and also in sewerage systems are known per se, for instance from FR2660730. It will be understood that such inspection system will be equipped with any electronic and optical inspection systems as available in the state of the art, including a camera for visual inspection and/or for infrared inspection (this could be the same or a different camera), light sources including flash lights, light emitting diodes and the like for illumination, electronic equipment for gps coordination, distance analysis tools. Specific tools highly suitable for use in a sewerage system include a laser, and software for image recognition. Evidently, such image recognition software could alternatively be present in the monitoring system at the other end of the cable connection 190. Specifically, the inspection robot 90 further comprises a tool 91 for inspection of branch pipes 20A, 20B. Thereto, the said tool is provided on a shaft that is telescopic so as to enable inspection along the full length of a branch pipe 20A, 20B. The inspection step is to provide information as to the length of a cable to be provided from building 22A to the access point 12, as well as to identify areas at which it is not feasible to provide clips to the first cable 1A. Furthermore, general information in relation to the sewerage system may be gathered, particularly in relation to the type of sewerage system as well as the actual state thereof.

FIG. 1B shows a second stage in the method of the invention, in which a first cable 1A is provided from the building 22A into the first branch pipe 20A and then through the entrance 15A into the main pipe 10 so as to arrive at the access point 12. Use is made of a truck 99 that provides the first cable 1A. It enters the first branch pipe 20A at the side of the building 22A, typically just outside the building 22A or below the building 22A. In the event that the building comprises a plurality of apartments and/or offices and/or other units, a plurality of first cables 1A could be provided. Suitable, such plurality of signal cables is then put together into one or more physical cables. Alternatively, some electrical integration so as to modulate signals in different frequency bands in one cable may be applied if desired and/or necessary. It is herein preferred that the number of first cables 1A entered into the first branch pipe 20A remains limited, while the first cable 1A remains sufficiently flexible so as to accommodate through curves and around corners. In one further embodiment, a first cable 1A provides a plurality of individual signal cables. Such cable multiplication may be provided for future use, for instance in case of the need for the provision of a new access after for instance change in ownership or use of the building 22A.

In this embodiment, clips 24 are connected to the first cable 1A prior to insertion of the first cable 1A into the first branch pipe 20A. In order to fit into the first branch pipe 20A, the clips 24 are thereto provided in a transport configuration, in which their lateral extension is less than the diameter of the first branch pipe 20A. The clips 24 are suitably attached on locations identified in the inspection step and/or outside locations identified in the inspection step as unsuitable areas. In an alternative embodiment, clips 24 may be applied after insertion of the first cable 1A into the first branch pipe 20A. Then, marking of the first cable 1A for identification of either suitable clip locations or unsuitable areas is preferred. Also in case of attachment of the clips 24 to the first cable 1A prior to insertion into the first branch pipe 20A, marking may be applied as an intermediate step.

The first cable 1A is suitably marked on the basis of the inspection data collected by the inspection robot 90 in step 1. Suitably, the inspection robot identifies areas along the length of the first branch pipe 20A, which areas are to be left free of clips 24. This for instance relates to sharp corners and location at which the first branch pipe 20A is damaged or at which there is a physical transition between a first pipe portion and a second pipe portion. Such unsuitable areas together with a further parameters may then be used to calculate marking positions for the attachment of clips. Other factors suitably contributing to the calculation of the marking positions include a desired distance between neighbouring clips, the number and sharpness of curves, the steepness of the first branch pipe 20A in vertical direction, likely having an impact on the flow speed and therewith the resistance needed to keep the first cable 1A in an accurate position. Also the orientation of curves is suitably identified, so as to ensure that the first cable 1A suitably is provided in the inner side rather than the outer side of a curve in the first branch pipe 20A.

FIG. 1B moreover shows a robot 92, with a cable connection 192 and a lasso tool 93. This lasso tool comprises a suitably shaped aperture, for instance in the form of an half cylinder. FIG. 5A shows a cross-sectional drawing of the robot 92 in more detail. FIG. 5B shows a top view on the robot 92. The robot is provided with a body 180 provided with wheels so as to enable movement in the main pipe 10. It is further provided with a lamp 190 that is located on an upper side of the body 180. The lamp 190 may be equipped to provide light in any desired form, including spectroscopic light of a certain frequency. In this embodiment, the lamp 190 is provided with a reflector present within the illuminated area, so as to provide a better illumination of the pipe. The situation may thus be registered with a camera of the robot 92. The robot 92 is further provided with a bumping body 185, which is in this embodiment shaped in the form of a half moon. The lasso tool 93 encloses an aperture 193 with which an end of the first cable 1A is caught. The robot thereafter draws the first cable 1A to the access point 12. The first cable 1A (or an additional cable inserted in the first branch pipe 20A therewith) is provided with an element at its tip. This element has a weight so as to facilitate the insertion of the first cable 1A into and through the first branch pipe 20A. In one embodiment, particularly in combination with the use of an additional cable, the element may be a nozzle for spreading liquid around. This provision of a nozzle allows to carry out a cleaning step simultaneously with the introduction of the first cable 1A. In a further embodiment, not shown, the robot 92 is provided with a clamping section for the first cable 1A. This clamping section is suitably included in the lasso tool 93. It serves to hold the first cable 1A after catching, such that the robot 92 can be moved within the main pipe 10 to the access point 12 without loosing the first cable 1A. The clamping section may be in the form of a robot arm that holds the cable. The clamping section may alternatively be in the form of a narrow space between a first and a second plate, wherein the first cable 1A gets clamped. The narrow space may alternatively be a channel, through which the first cable 1A arrives in a holder. Suitably, the clamping section is located such the first cable 1A is automatically moved towards the clamping section when the robot 92 starts moving. In FIG. 5, this will be the front side (e.g. the side to which the lamp faces).

FIG. 1c shows a third stage in the method. The first cable 1A is herein inserted into the cable trunk 2 through an aperture 3 therein. The cable trunk 2 is in this embodiment provided at the access point 12. The cable trunk suitably comprises several apertures 3. These have been applied on locations identified by the inspection robot 90 in the first step as shown in FIG. 1A. Suitably the second cable 1B (for a location further away from the access point 12) is entered into the cable trunk 2 before the first cable 1A is entered therein. While not shown, use may be made of a further robot equipped with drawing means, so as to draw the cable trunk 2 into the main pipe 10. It is observed that the present embodiment wherein the cable trunk 2 is provided from the access point 12 is an alternative over one method, wherein the cable trunk 2 is provided into the main pipe 10 prior to the arrival of the first cable 1A into the main pipe 10 from the entrance 15A of the first branch pipe 20A. In the latter embodiment, the first cable 1A would be inserted directly into the cable trunk 2. The tip of the first cable 1A may thereto be provided, in one embodiment, with magnetic means, so that the first cable 1A may be drawn through the trunk 2 by magnetic forces. In that embodiment, the robot 90 is suitably provided with a magnet to induce said magnetic force on the tip of the first cable 1A. As shown in FIG. 1c, clips 14 are attached to the cable trunk 2 prior to insertion thereof into the main pipe 10. This is one embodiment, but the clips 14 may also be provided after insertion of the cable trunk 2 into the main pipe. One method for insertion of a cable trunk 2 provided with clips 14 into the main pipe 10 is known from EP1868020A1. A method for the provision of clips 14 after insertion of the cable trunk 2 is for instance known from DE19813728A1.

FIG. 1d shows a fourth stage of the method wherein the clips 14, 24 are brought from a transport configuration into an attachment configuration. This transformation of the clips is typically carried out with robots 94, 96. The robot 94 is provided with a cable connection 194. The robot 96 is suitably provided with a cable connection (not shown). It will be clear that such cable connections are merely implementations. A cutting tool may be sufficient for carrying out the transformation of the clips, particularly when the clips are provided with a first and a second leg that are kept together with a rope or other means that can be removed by cutting. A closure 13 of the access point 12 is shown in this Figure as well. This transformation of the clips 14, 24, could alternatively be done with a single robot. However, due to the difference in diameter between the main pipe 10 and the first branch pipe 20A, it is deemed preferable to use different robots.

FIG. 1E then shows the fifth stage of the present invention, wherein a guide member 40 is introduced into the entrance 15A of the first branch pipe 20A. This guide member 40 is designed so as to guide the first cable 1A to a desired angular position into the first branch pipe 20A. Use is made herein of a robot 97 provided with a cable connection 197. This robot is thereto embodied with a guide member storage facility in which one or more guide members are stored and moved from the access point 12 or another access location to the entrance 15A of the first branch pipe 20A. The design of the robot 97 may be conventional.

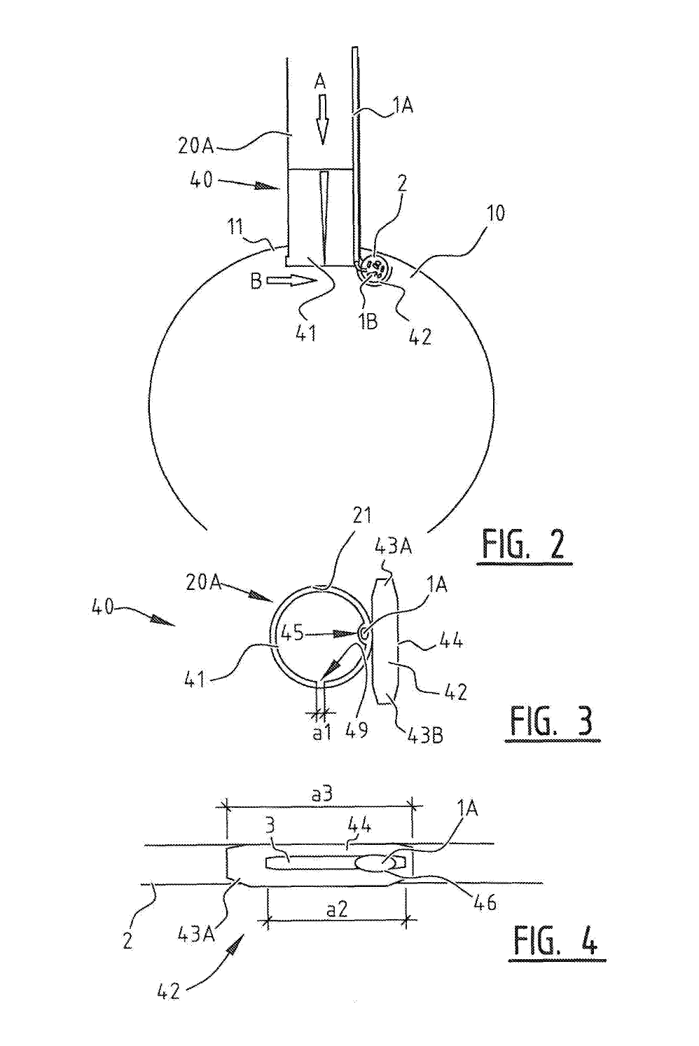

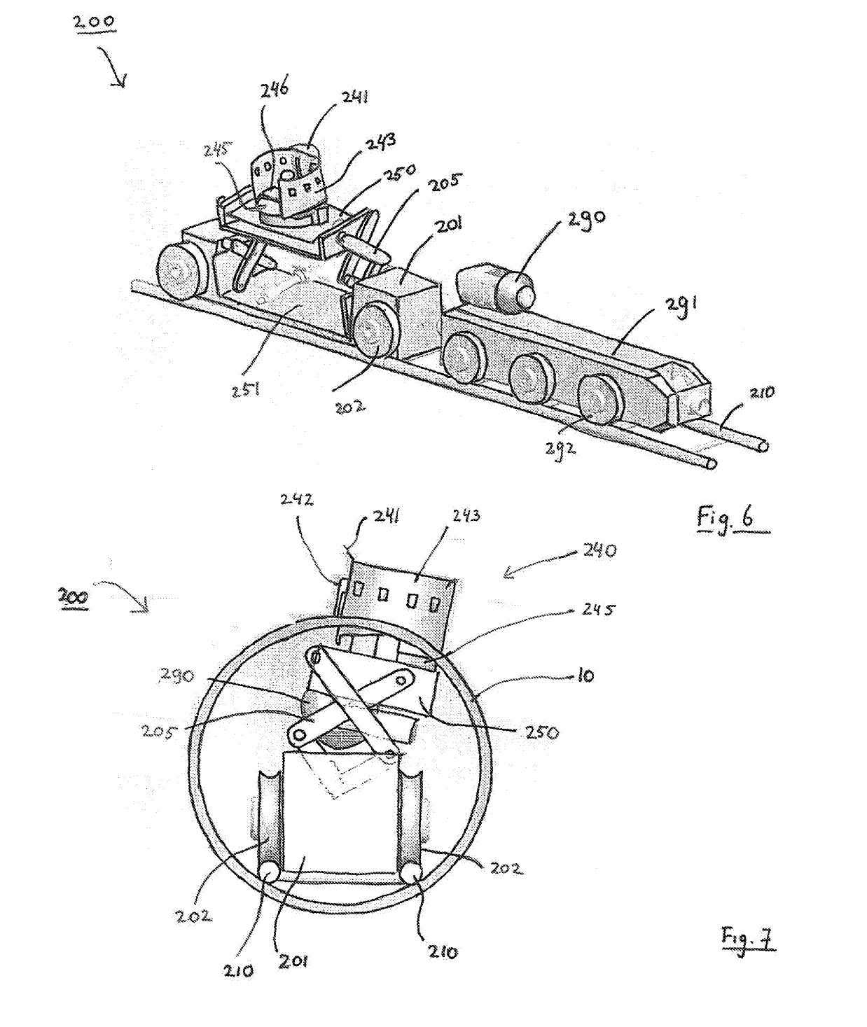

FIG. 2-4 show the guide member 40 in more detail. FIG. 2 is herein a diagrammatical cross-sectional view. FIG. 3 is a top view from the inside of the first branch pipe 20A onto the guide member 40, corresponding to the arrow A shown in FIG. 2. FIG. 4 is a side view from the inside of the main pipe 10 corresponding to the arrow B shown in FIG. 2. The guide member 40 comprises a sleeve 41 and a trunk support part 42, or clamp. The clamp extends at least partially around the cable trunk 2. In this embodiment, the angular extension around the cable trunk 2 is between 150 and 210 degrees, for instance approximately 180 degrees. The cable trunk 2 is herein fixed at the upper side 11 of the main pipe 10 to an inner surface thereof. As is clearly visible herein, the cable trunk 2 comprises several cables, for instance the second cable 1B. The first cable 1A extends between the sleeve 41 and an inner surface 21 of the first branch pipe 20A. This is most clearly visible in FIG. 3. This FIG. 3 further shows that the first cable 1A is located in a recess 45. The recess 45 constitutes thus a cable guide to guide the cable to an upper side of the guide member and at a desired angular location at the inner side of the first branch pipe 20A. Such position is desired, as will be clear from FIG. 3, and prescribed by the shape of the guide member: the shape of the guide member 40 prescribes that the recess 45 is on the same side as the clamp.

In order to bring the first cable 1A in the desired angular position, the sleeve 41 is suitably introduced into the first branch pipe 20A, but not completely, such that rotation remains possible. Additionally, the sleeve comprises a gap portion 49 with a width a1. The sleeve 41 is moreover put under some pressure, such that it will exert a force to get a larger diameter. It thus clamps itself into the first branch pipe 20A and can overcome tolerances in the diameter thereof. Tuning of the gap 49 can moreover be used to allow rotation of the sleeve.

As shown in both FIG. 3 and FIG. 4, the trunk support part has in the shown embodiment clamping portions 43A, 43B and a protective member extending in between thereof. The clamping portions 43A, 43B have a slightly reduced diameter, which ensures appropriate clamping. The protective member has a window 46 which is positioned so as to overlap with the aperture 3 in the trunk 2. The window 46 is herein ovally shaped, which appears suitable to minimize scratching of the first cable 1 to an edge of the window 46. The window 46 extends herein over a smaller portion than the aperture 3; this allows fine tuning of the position of the cable trunk 2 relative to the first branch pipe 20A. Still, the function of the protective member 44 to protect the cable trunk 2 and the cable therein against aggressive cleaning with chemical and particularly mechanical means is maintained. It is observed that the protective member 44 is desired at the entrance of the first branch pipe 20A and not along the main pipe halfway the entrances 15A, 15B of the first and second branch pipes 20A, 20B, since the entrances 15A, 15B needs cleaning more, there is an aperture 3 in the cable trunk 2 and the presence of the first branch pipe 20A has the consequence that chains and the like can arrive from different, unexpected directions to the cable trunk 2. Besides specifying an axial position, the window 46 also and in this embodiment even more specifically requires an orientation of the cable trunk relative to the first branch pipe 20A. The length a2 of the aperture 3 and the length a3 of the clamp 42 are herein indicated to show that preferably the clamp 42 is longer than the aperture 3. When the cable trunk 2 is correctly positioned axially, the aperture 3 will be fully covered by the protective member 42.

FIG. 6 shows in a diagrammatical, bird eye's view a sewerage pipe robot 200 of the present invention for insertion of the guide member into an entrance of a first branch pipe. FIG. 7 is a view from inside the main pipe 10 of the sewerage system on the robot 200. The robot 200 is present on rails 210 and comprises a locomotive body 291 and a second wagon 201. Wheels 202, 292 are in contact with the rails 210. This configuration with rails and a locomotive is however by no means essential and the skilled person may envisage other options. The locomotive body 291 further comprises a inspection device 290, which is also known per se in the art.

The second wagon 201 of the robot 200 comprises a lift 205 and a rotatable member 240. As can be very clearly seen in FIG. 7, the lift 205 does not merely allow to bring platform 250 upwards, but also is able to give a specified orientation to this platform 250, such that the rotatable member 240 attached to said platform 250 is oriented towards the entrance of a first branch pipe. As a result, as is further clear from FIG. 7, the rotatable member can enter, at least partially said entrance of the first branch pipe. If the inspection tool 290 is not able to indicate the exact location of the entrance of said branch pipe, a further inspection tool, particularly a camera could be provided in the rotatable member 240, so as to view the entrance, while being moved into said entrance.

The rotatable member 240 comprises several elements. A first element is the mount 245 which is actually rotating, when driven to do so. Connected to this rotatable mount 245 is an upstanding wall 243. This wall is designed to be circumferential around a sleeve of the guide member. It is understood that the wall 243 could alternatively be designed that the sleeve would fit around the wall. However, a location of the sleeve within the wall 243 appears preferable so as to protect the first cable that is located at the outside of said wall 243. A lid 241 and a further member 242 are provided so as to facilitate the insertion of the rotatable member 240 into and out of the entrance of the first branch pipe.

A gap 246 is present in upstanding wall 243, where the trunk support part of the guide member is to be located. The rotation allows to bring said gap at the side facing the inner wall of the main pipe, particularly at the lower side of the entrance of the first branch pipe. Here, the connection between the aperture between the sleeve and the aperture in the cable trunk is shortest, and thus best for guiding the first cable. The embodiment of the robot 200 as shown in FIGS. 7 and 8 does not have any functionality for positioning the cable trunk to the trunk support part of the guide member. A separate gripper could be used therefore. In fact, it appears advantageous so as to arrange the insertion of the cable trunk into the trunk support part, after that the guide member has been assembled into the rotatable member 240. There is no need that this occurs opposite the entrance of the first branch unit. In fact, such operation may be carried out at or near an access point 12 as shown in FIG. 1A, and it could also be carried out manually.

In summary, the guide member (40) of the invention comprises a sleeve (41) for positioning into an entrance (15A) of a first branch pipe (20A) in a sewerage system, which entrance (15a) provides access to a main pipe (10), wherein a telecommunication cable system is inserted into said sewerage system, which telecommunication cable system comprising a cable trunk (2) present in the main pipe (10) and housing a plurality of cables (1A, 1B), of which plurality of cables a first cable (1A) extending into the first branch pipe (20A), wherein a first aperture (3) is present in said cable trunk (2) at or near the entrance (15A) of the first branch pipe (20A) through which the first cable (1A) leaves the cable trunk (2), which said guide member (40) comprises a trunk support part (42) projecting into the main pipe (10) and positioning the cable trunk (2) in a desired angular position near the entrance (15A) of the first branch pipe (20A), which guide member (40) further comprises a cable guide (45) for supporting the first cable (1A) at an outside of the sleeve (41), characterized in that the trunk support part (42) comprises a protective member with a window, through which that the aperture (3) is substantially aligned to said cable guide (45).

### LIST OF FIGURES

1A. First cable
1B Second cable
10 Main pipe
20A First branch pipe
20B Second branch pipe
15A Entrance of the first branch pipe 20A
15B Entrance of the second branch pipe 20B
24 Clips in the branch pipes
14 Clips in the main pipe
2 cable trunk
3 (first) aperture in the cable trunk
12 access point
13 closure of the access point
22A building coupled to first branch pipe 20A
22B building coupled to second branch pipe 20B
40 Guide member
41 sleeve
42 clamp
90 inspection robot
92 catching robot
93 lasso
94 first positioning robot
95 cutting tool
96 second positioning robot
99 truck
11 top side of the main pipe
180 body of robot 92
185 bumping body
193 aperture in lasso 93
191, 192, 194 cable connections to robots 91, 92, 94

1. A guide member comprising a sleeve for positioning into an entrance of a first branch pipe in a sewerage system, which entrance provides access to a main pipe, wherein a telecommunication cable system is inserted into said sewerage system, which telecommunication cable system comprising a cable trunk present in the main pipe and housing a plurality of cables, of which plurality of cables a first cable extending into the first branch pipe, wherein a first aperture is present in said cable trunk at or near the entrance of the branch pipe through which the first cable leaves the cable trunk,
which said guide member comprises a trunk support part projecting into the main pipe and positioning the cable trunk in a desired angular position near the entrance of the branch pipe, which guide member further comprises a cable guide for supporting the cable at an outside of the sleeve,
characterized in that the trunk support part comprises a protecting member covering the cable trunk over a predefined distance at least at a side facing away from an adjacent inner surface of the main pipe, which protecting member comprises a window, through which the first aperture of the cable trunk is to be exposed.

2. The guide member as claimed in claim 1, wherein a clamp is present for fixation of the cable trunk into a desired axial position and orientation relative to the first branch pipe, such that the first aperture is substantially aligned to said cable guide.

3. The guide member as claimed in claim 1, wherein the window is arranged for fine tuning the axial position of the trunk.

4. The guide member as claimed in claim 3, wherein the window has a smaller size than the first aperture.

5. The guide member as claimed in claim 1, wherein the window is ovally shaped, said oval shape having a first and a second diameter in respectively the axial direction and the angular direction of the trunk, said first diameter being larger than the second diameter.

6. The guide member as claimed in claim 1, wherein the cable guide comprises a recess into the sleeve, said recess extending in a longitudinal direction along the sleeve.

7. The guide member as claimed in claim 1, wherein at least the protecting member comprises a metal, such as steel.

8. A method of positioning a first cable into a sewerage system comprising a main pipe and a first branch pipe with an entrance in the main pipe, comprising the steps of:
Providing the first cable into the first branch pipe and extending to the main pipe;
Inserting the first cable into a cable trunk through an aperture in the cable trunk, and moving the cable trunk thereafter to a location at or near the entrance of the first branch pipe;
Introducing a sleeve of a guide member into the entrance of the first branch pipe, wherein the first cable is arranged between a surface of the first branch pipe and the sleeve, the guide member being provided with a cable guide thereto;
Positioning the cable trunk to a desired angular position relative to the entrance of the first branch pipe by getting it supported through a trunk support part of the guide member, and
Defining a desired axial position and orientation of the cable trunk relative to the first branch pipe by means of a protective member with a window of the cable trunk part, said definition step of the desired axial position and orientation further comprising a step of aligning said window relative to the first aperture.

9. The method as claimed in claim 8, wherein the defined position is fixated by clamping the cable trunk into a clamp that is part of the trunk support part, such that the first aperture is substantially aligned to said cable guide.

10. The method as claimed in claim 8, wherein the cable guide of the guide member comprises a recess into the sleeve, and wherein upon introduction of the sleeve into the entrance of the branch pipe, the first cable is brought into the recess.

11. The method as claimed in claim 10, wherein sleeve is rotated after that the first cable has brought into the recess so as to define a desired angular position of the first cable relative to the cable trunk.

12. The method as claimed in claim 10, wherein the sleeve is fixed into the first branch pipe after that the first cable has been brought to the desired position.

13. The method as claimed in claim 8, wherein a resin is applied onto a top portion of the sleeve and an adjacent surface of the first branch pipe, said top portion being located away from the entrance, so as to cover any space between the sleeve and the surface of the first branch pipe.

14. The method as claimed in claim 8, wherein a hose is applied to the first cable, such that the hose is present around a portion of the first cable, which portion is positioned, after positioning of the cable trunk, at least substantially in the first branch pipe and which portion includes the cable segment being located along the sleeve of the guide member.

15. Use of the guide member claim 1 for insertion into an entrance of a first branch pipe in a sewerage system and for protection of a first cable extending from the first branch pipe into a main pipe of the sewerage system.

16. Use as claimed in claim 15, wherein said guide member is used for guiding the first cable in the first branch pipe between an outside of a sleeve of said guide member and a wall of said first branch pipe and for positioning and supporting a cable trunk on a trunk support part of the guide member, therewith also guiding the first cable from said position between sleeve and wall to an aperture in said cable trunk positioned on the trunk support part and exposed through a window in a protective member of the guide member.

17. A sewerage pipe robot for positioning a sleeve of a guide member into an entrance of a first branch pipe in a main pipe of a sewerage system, the said robot comprising a lift and a rotating member with which the guide member can be positioned and inserted.

18. The sewerage pipe robot as claimed in claim 17, wherein the lift is provided with a rotatable chassis, such that the rotating member may be positioned into the entrance of a first branch pipe that is located adjacent to the top of the main pipe.

19. The sewerage pipe robot as claimed in claim 17, wherein the rotating member comprises an upstanding wall corresponding with the shape of the sleeve of the guide member, and for circumference of said sleeve, said wall leaving a gap for the trunk support part of the guide member.

20. A system of a sewerage pipe robot as claimed in claim 17 and a guide member, for insertion of the guide member into the entrance of the first branch pipe.

21. The system of claim 20, further comprising a cable trunk with an aperture that is positioned and supported by the trunk support part of the guide member, and which is taken up with the guide member by the robot.

22. The system of claim 20, further comprising a first cable extending from the first branch pipe between the sleeve of the guide member and an inner wall into the cable trunk via its aperture.

23. Use of the sewerage pipe robot as claimed in claim 17 for positioning a guide member into an entrance of a first branch pipe in a main pipe of a sewerage system, without damaging a first cable extending from said branch pipe into the main pipe.

24. A sewerage pipe robot for catching a first cable extending from a first branch pipe into a main pipe of an sewerage system, said first cable being provided with a block at its tip section, said robot comprising a lasso for catching said block at its tip section.

25. Use of the sewerage pipe robot as claimed in claim 24 for use in catching the first cable.
